(19) United States
(12) Patent Application Publication
(10) Pub. No.: US 2025/0199847 A1
(43) Pub. Date: Jun. 19, 2025

(54) AUTOMATIC PLACEMENT OF MICROSERVICES WITH REINFORCEMENT LEARNING

(71) Applicant: NEC Laboratories America, Inc., Princeton, NJ (US)

(72) Inventors: Kunal G. Rao, Monroe, NJ (US); Giuseppe Coviello, Robbinsville, NJ (US); Srimat Chakradhar, Manalapan, NJ (US)

(21) Appl. No.: 18/976,625

(22) Filed: Dec. 11, 2024

Related U.S. Application Data
(60) Provisional application No. 63/610,635, filed on Dec. 15, 2023.
(60) Provisional application No. 63/621,242, filed on Jan. 16, 2024.

(51) Int. Cl. G06F 9/48; B60W 50/06; B60W 60/00; G06N 20/00

(52) U.S. Cl. CPC G06F 9/4806; B60W 50/06; B60W 60/001; G06N 20/00

(57) ABSTRACT

Systems and methods for automatic placement of microservices with reinforcement learning. Actions for an agent based on states and an associated reward for the actions based on the cost and latency of microservices of a distributed computing application can be learned by a reinforcement learning model. An optimal action based on the actions having the top ranked associated reward that maximizes a reward value based on the cost and the latency of microservices can be generated with the reinforcement learning model. The microservices can be placed to an optimal location that satisfies the latency and the cost of the microservices within a cloud and edge computing environment based on the optimal action.

### RELATED APPLICATION INFORMATION

This application claims priority to U.S. Provisional App. No. 63/610,635, filed on Dec. 15, 2023; and to U.S. Provisional App. No. 63/621,242, filed on Jan. 16, 2024; incorporated herein by reference in their entirety.

### BACKGROUND

### Technical Field

The present invention relates to optimizing microservices performance in cloud and edge computing environments and more particularly to automatic placement of microservices with reinforcement learning.

### Description of the Related Art

In recent years, edge computing has emerged as a new computing paradigm. Edge computing refers to processing capability at the edge of the network, which is close to the source of data. Edge resources can be mobile as in a vehicle or smartphone, they can be static as in a manufacturing plant, traffic intersection, construction site or offshore oil rig, they can be a mixture of the two, as in hospitals, or they can be in a telecommunication provider's data centers at the edges of the cellular network. In these cases, edge resources are used solely to meet application-specific requirements like short response times, privacy, or the ability to do local analysis. However, unlike in the cloud, resources at the edge are limited.

### SUMMARY

According to an aspect of the present invention, a computer-implemented method is provided, including, learning actions for an agent based on states and an associated reward for the actions based on a cost and latency of microservices of a distributed computing application with a reinforcement learning model, generating an optimal action based on a top ranked action with an associated reward that maximizes a reward value based on the cost and the latency of microservices with the reinforcement learning model, and placing the microservices to an optimal location within a cloud and edge computing environment that satisfies the latency and the cost of the microservices based on the optimal action.

According to another aspect of the present invention, a system is provided including a memory device, one or more processor devices operatively coupled with the memory device to perform operations including, learning actions for an agent based on states and an associated reward for the actions based on a cost and latency of microservices of a distributed computing application with a reinforcement learning model, generating an optimal action based on a top ranked action with an associated reward that maximizes a reward value based on the cost and the latency of microservices with the reinforcement learning model, and placing the microservices to an optimal location within a cloud and edge computing environment that satisfies the latency and the cost of the microservices based on the optimal action.

According to yet another aspect of the present invention, a non-transitory computer program product is provided including a computer readable storage medium having program code for automatic placement of microservices with reinforcement learning, wherein the program code when executed on a computer causes the computer to perform operations further includes, learning actions for an agent based on states and an associated reward for the actions based on a cost and latency of microservices of a distributed computing application with a reinforcement learning model, generating an optimal action based on a top ranked action with an associated reward that maximizes a reward value based on the cost and the latency of microservices with the reinforcement learning model, and placing the microservices to an optimal location within a cloud and edge computing environment that satisfies the latency and the cost of the microservices based on the optimal action.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for automatic placement of microservices with reinforcement learning, in accordance with an embodiment of the present invention;

FIG. 2 is a block diagram showing a system implementing practical applications for the automatic placement of microservices with reinforcement learning, in accordance with an embodiment of the present invention;

FIG. 3 is a block diagram showing a computing device implementing automatic placement of microservices with reinforcement learning, in accordance with an embodiment of the present invention;

FIG. 4 is a block diagram showing hardware and software components employed to perform the operations in automatic placement of microservices with reinforcement learning, in accordance with an embodiment of the present invention; and

FIG. 5 is a block diagram showing a structure of deep neural networks for automatic placement of microservices with reinforcement learning, in accordance with an embodiment of the present invention.

### DETAILED DESCRIPTION OF PREFERRED EMBODIMENTS

In accordance with embodiments of the present invention, systems and methods are provided for automatic placement of microservices with reinforcement learning.

In an embodiment, actions for an agent based on states and an associated reward for the actions based on the cost and latency of microservices of a distributed computing application can be learned by a reinforcement learning model. An optimal action based on the actions having the top ranked associated reward that maximizes a reward value based on the cost and the latency of microservices can be generated with the reinforcement learning model. The microservices can be placed to an optimal location that satisfies the latency and the cost of the microservices within a cloud and edge computing environment based on the optimal action.

Modern applications can be written as a collection of microservices. Using microservices provide at least the following advantages: microservices are easy to develop, deploy, and maintain compared to a complex singular application. Each microservice can be written in different programming language which is suitable for the specific task. Microservices can be independently updated, replaced and scaled. Troubleshooting and identifying bugs or performance bottlenecks in end-to-end application pipeline becomes easy.

By dividing a distributed computing application into microservices, the total application latency is the sum of the processing time of each microservice and the time for communication between them. For streaming applications, the input is received by the first microservice in a pipeline while noting that microservices can perform different analytics on the input, and finally the output is delivered by the last microservice in the pipeline. Depending on the input data, the processing time for microservices varies and overall end- to-end application latency changes.

As the workload increases, processing solely at the edge server can lead to slower response times e.g., increased latency, because the edge server cannot handle the increased workload. In such situations, resources in the cloud server can be utilized and the additional workload can be processed in the cloud.

Additionally, the workload experienced by applications can vary. For example, in video analytics applications, the workload can depend on the video scene content, which continuously changes e.g. for license plate recognition application, the workload can be determined by the number of cars in the scene, whereas for a face recognition application, workload can be determined by the number of faces in the scene. Since cars and people keep moving, and the total number of cars or people in the scene can go up or down, the overall workload experienced by video analytics applications continuously fluctuates.

When application workload fluctuates, the latency of the application is directly impacted. When workload is low, processing at the edge is quick, but as workload increases, cloud resources can be leveraged in order to keep the latency low. Now, at what point does the workload become too much for the edge to handle and when the cloud resources can be leveraged? The answer can depend on the compute capability available at the edge server and the latency that can be tolerated by the distributed computing application. Let's say the tolerable latency for an application is 500 milliseconds. As the workload increases, an edge node with low compute power will have to leverage cloud resources much sooner than an edge node with higher compute power in order to deliver insights within 500 milliseconds. Thus, for different infrastructure deployments, the point at which it makes sense to leverage cloud resources can vary.

The cost of computing on the edge is typically a one-time investment, whereas the cost of cloud computing resources is pay-per-use. Thus, whenever cloud resources are used, the overall cost of operation goes up. Therefore, cloud resources can be used judiciously to limit the cost.

The present embodiments propose automatic placement of microservices with reinforcement learning, which is aware of the end-to-end application latency and the cost of application operation. The present embodiments can use this knowledge to judiciously place microservices on edge and cloud computing continuum, such that additional cost is incurred due to latency requirements. By doing so, the cost and the resources are utilized in an efficient and effective manner. The present embodiments can dynamically change placement of application microservices between edge and cloud computing infrastructure, and is able to ensure the desired application latency is always met, while reducing the cost of operation.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

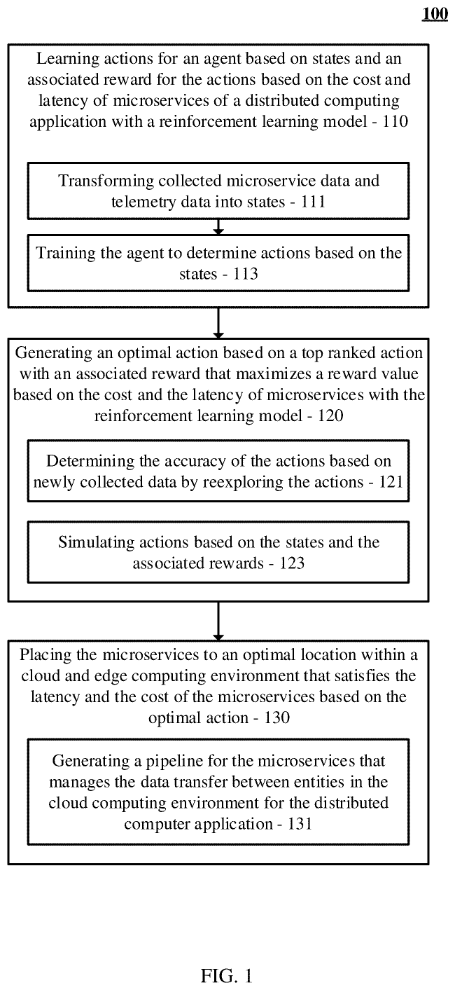

Referring now in detail to the figures in which like numerals represent the same or similar elements and initially to FIG. 1, a flow diagram of a high-level overview of a computer-implemented method for automatic placement of microservices with reinforcement learning is illustratively depicted in accordance with an embodiment of the present invention.

In an embodiment, actions for an agent based on states and an associated reward for the actions based on the cost and latency of microservices of a distributed computing application can be learned by a reinforcement learning model. An optimal action based on the actions having the top ranked associated reward that maximizes a reward value based on the cost and the latency of microservices can be generated with the reinforcement learning model. The microservices can be placed to an optimal location that satisfies the latency and the cost of the microservices within a cloud and edge computing environment based on the optimal action.

The present embodiments can dynamically manage placement of stream processing application pipeline components (e.g., microservices) on edge-to-cloud computing continuum. In order to do so, there can be application-specific details that the user provides. These details can be specified in a specified format (e.g., YAML). The specification can include microservice data which can include the application topology, which lists the various microservices that are part of the application pipeline and how they are inter-connected, and telemetry data that can be measured periodically by the present embodiments in order to make placement decision.

In block 110, actions for an agent can be learned based on states representing microservice data and an associated reward for the actions by employing reinforcement learning model.

In reinforcement learning, the state is an observable scenario within an environment at a particular time. The present embodiments can perform reinforcement learning (e.g., state-action-reward-state action) to generate an optimal action to optimally place the workload to an optimal location within the cloud and edge computing environment.

In block 111, collected microservice data and telemetry data can be transformed into states. The present embodiments define the states as the workload experienced at any given time. The workload can include microservice data and telemetry data. To transform the microservice data and telemetry data into states, tuples of microservice data and telemetry data can be defined and stored into a database which shows a specific representation of the environment (e.g., cloud and edge computing environment) at a given time.

The microservice data can include the data for running a distributed computing application such as configuration, data dependencies, input data, output data, etc. The microservice data can include a topology specification. The topology specification for the application pipeline consists of sensors and streams specification. Each sensor can specify the name of the sensor, the name of the driver that will be used by the sensor, the sensor configuration to run, and optionally any node on which it can run. Each streams specification can include the name of the stream, and any configuration parameters that can be passed to the stream and the list of inputs to the stream. These inputs can be names of other sensors or streams that are part of the pipeline. The inter-connection between microservices can be specified through the inputs specification.

Telemetries data can include the list of different telemetry data points that guide in determining appropriate placement at runtime. Each telemetry data can include the name of the data point, the method to be used to obtain the telemetry data, the source from where the data can be obtained and the path to the field whose value can be fetched from the output of source. The telemetry method can be subscribe, if the telemetry data can be measured from other sensors or streams which belong to the application pipeline or it can be restAPI, if the telemetry data can be measured from an external hypertext transport protocol (HTTP) based representational state transfer (REST) application programming interface (API) call. The source can include the name of the sensor or stream (for subscribe), or the url (for restAPI). The output from source can be in JavaScript Object Notation (JSON) format and fieldPath specifies the list of keys to be navigated within the JSON output to fetch the value of telemetry data point.

In block 113, the agent can be trained to determine actions based on the states.

The present embodiments can define the actions within the action space as modes. Each mode can specify the placement for different sensors and streams, and together can form a single action. Thus, the total actions available to the RL agent is the same as the total modes.

The modes can include the list of different placement options that the present embodiments can perform. Within each mode, the placement for each of the sensors and streams belonging to the application pipeline can be specified. The modes vary depending on the telemetries or the state of the environment.

The present embodiments can define associated rewards of actions based on the cost of operation and the latency of the microservice being performed. The associated rewards can be grouped in at least four scenarios:

Scenario 1: latency is satisfied at low cost. The associated reward can be fixed with a high reward value (e.g., 100). The logic here is to encourage edge usage when latency can be satisfied on edge.

Scenario 2: latency is satisfied at high cost. The associated reward can be low reward value (e.g., 20) and is inversely proportional the percentage of latency measured. The percentage of latency can be calculated by what percentage is the latency below the specified latency threshold and as this percentage increases, the associated reward deteriorates. The logic here is to increasingly discourage cloud usage to unnecessarily achieve much lower latency than specified in latency Threshold.

Scenario 3: latency is not satisfied at low cost. The associated reward can be low reward vakye (e.g., 20) and is inversely proportional the percentage of latency measured. The percentage of latency can be calculated by what percentage is the latency above the specified latency threshold and as this percentage increases, the reward deteriorates. The logic here is to increasingly discourage edge usage when latency cannot be satisfied and encourage cloud usage to satisfy the specified latency Threshold.

Scenario 4: latency is not satisfied at high cost. The reward can be fixed with low reward value (e.g., 10). The logic here is to discourage cloud usage since latency is not being satisfied even with abundant cloud resources.

To learn the action, an agent interacts with the environment and builds up a model to determine appropriate actions for a given state, in order to maximize the reward. The model can include q-values for each state and action pair, which is denoted as Q(s, a). The core update equation for these q-values is shown here: Q(s, a)←Q(s, a)+α[r+y×Q(s, a)−Q(s, a)] where a is the learning rate and γ is the discount factor. a controls how much weight is to be given to new information while γ determines the importance of future rewards.

In order to train the agent, the agent explores and interacts with the environment.

During this exploration, the agent takes random actions for a given state and learns the impact of those actions through the received reward or penalty. By repeating these actions for different states, over a period of time, the RL agent builds up q-values for different Q(s, a).

In block 120, an optimal action based on the actions having the top ranked associated reward that maximizes a reward value based on the cost and the latency of microservices can be generated with the reinforcement model.

The optimal action can include the action that maximizes the reward for a given state. To determine optimal action, the actions and their associated rewards can be ranked based on the values of the associated rewards. The top-ranked actions can be stored as the optimal action.

Once the state-action pairs are explored, the agent is now ready to exploit and start using the learned information in taking the optimal actions which maximize the reward for a given state. A constant between 0 and 1 called as epsilon (ε) can be used to switch between exploration and exploitation phase. A random number between 0 and 1 can be generated and if the random number is less than ε, then exploration is performed, otherwise exploitation is performed. During exploration, ε can be set high (e.g. 0.9) and then during exploitation, ε can be set low (e.g. 0.1).

In block 121, the accuracy of the actions can be determined based on newly collected data by reexploring the actions. While RL agent exploits, it can also explore to see if the learnings can be revisited and adjusted to adapt to potential changes in the underlying infrastructure or system conditions detected in real-time e.g. change in load on the system or change in network capacity, etc., which are beyond RL agent's control.

In block 123, actions based on the states and the associated rewards can be simulated. The training of the RL agent different workloads (states) with different placements (actions) and measuring the actual end-to-end application latency and cost (reward) can be simulated to save time and resources. A simulator can be used that mimics the behavior of actual application running on the underlying edge and cloud computing infrastructure. The RL agent interacts within this simulated environment to learn the optimal actions for a given state which maximizes the reward. The simulator can fine-tune the RL agent and study the overall performance of automatic task placement. The simulator can utilize data from agent exploitations, including currently collected microservice and telemetry data, and fit the data into a quadratic equation using polynomial regression, to determine the optimal actions.

In block 130, placing microservices to an optimal location within a cloud and edge computing environment that satisfies the latency and the cost of the microservices based on the optimal action.

In order to orchestrate the placement of microservices on edge or cloud, the present embodiments can leverage a microservice orchestration platform which uses backend services to manage microservices on the cloud and edge computing environment.

The microservice orchestration platform can allow execution of microservices on multiple tiers of computing (e.g. from edge to the cloud). The tiers can be associated to zones by marking them with the zone label. Each zone corresponds to a specific tier of computing and through such demarcation of nodes.

In block 131, a pipeline for the microservices that manages the data transfer between entities in the cloud and edge computing environment for the distributed computer application can be generated. The microservice orchestration platform can also automatically manage entities (e,g., sensors, streams, gadgets,etc.) and connect them through a pipeline. The pipeline can include data management through the entities. A pipeline can be created for multiple instances of the system for each microservices within the cloud and edge computing environment.

The pipeline can include a cluster which further includes a “control” node and one or more “runner” nodes. Here, the “runner” nodes belong to different tiers (zones) e.g. edge or cloud and the present embodiments can manage dynamic placement of microservices on these different “runner” nodes.

The present embodiments use reinforcement learning based technique to automatically learn the optimal action that satisfies the latency and the cost of the microservice. The action chosen by the RL agent can be the placement that is applied. The optimal action can include the optimal location of the microservice being processed based on the optimal action. The optimal location can include the edge server, the central cloud server, intermediary server, or other locations within the cloud and edge computing environment.

To place the microservices to an optimal location, telemetry data can be obtained. In order to obtain telemetry data, the microservice orchestration platform can perform command line utility services. In order to initiate change in placement, the present embodiments can patch the pipeline and change its specification to be the desired mode of placement. This automatically triggers re-deployment of the application with the desired mode of placement. Each instance of application-specific backend separately records the learnings (q-values) in the database (running on “control” node), which is deployed as a common backend for all backends. This way, if a backend had to restart for any reason e.g. node shuts down due to loss of power or hardware failure, etc., the learnings are not lost and the present embodiments can resume its operation seamlessly from where it left off.

The present embodiments can continue to operate and manage placement of microservices as long as the pipeline is running on the microservice orchestration platform. As soon as the pipeline is removed, the microservice orchestration platform removes the corresponding application microservices e.g., sensors, streams, gadgets, and then finally, the microservice orchestration platform also removes corresponding backend. Thus, the lifecycle starts with registration of a pipeline and ends with its removal.

In another embodiment, the present embodiments can detect anomalies from the microservice data and the telemetry data that can be placed to an optimal location. For example, microservice data and telemetry data can become noticeably large due to increase bandwidth caused by large amounts of requests from a specific internet protocol (IP) address. The present embodiments can detect such anomaly and block packets or requests from the determined IP address.

In another embodiment, a rule-based placement can be performed. For rule-based task placement the “rules” to apply a particular placement mode is specified through condition using the telemetry data. The condition is provided as an expression which evaluates to true or false, and can use one or more of telemetry data names along with mathematical operators (+, −, *, /, %), equalities or inequalities (=, ==,!=, <, <=, >, >=), even join multiple of them using “AND” or “OR” to construct the expression, etc. At runtime, the present embodiments can automatically fill in the telemetry data values and leverages a parser to parse and evaluate the condition expression. In another embodiment, the present embodiments can alternate between rule-based placement and automatic placement based on the determined status of the cloud and edge computing environment. This switching point can be learned by a neural network based on past switches and the relevant telemetry data.

Thus, when the workload determined is low, edge resources can be used, whereas when the workload increases, then cloud resources can be used as well. With this condition expression, the present embodiments can dynamically adjust placement of microservices as the video content changes. However, the point at which it makes sense to use cloud resources varies with application and the compute power available at the edge. This condition specification can be done for one-off deployment but it is practically infeasible to manually evaluate and specify for each deployment scenario across different locations running different applications.

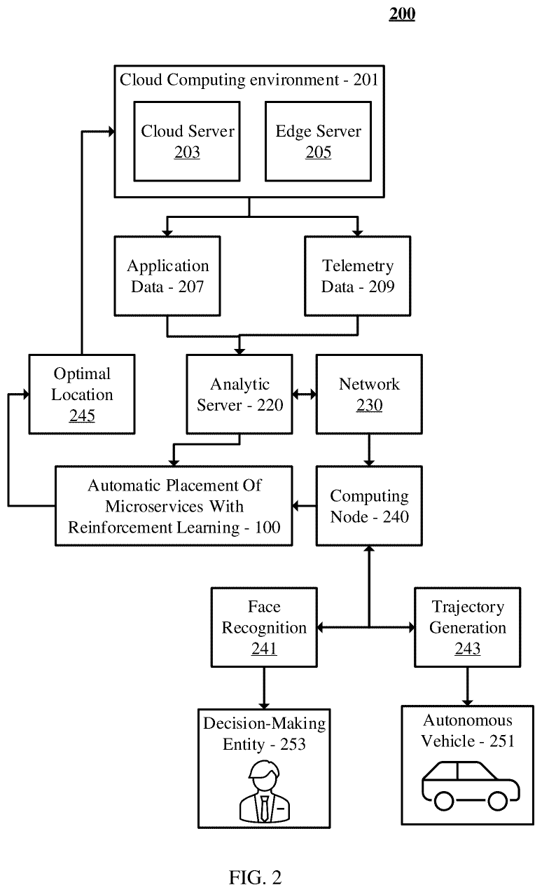

Referring now to FIG. 2, a block diagram showing a system implementing practical applications for the automatic placement of microservices with reinforcement learning, in accordance with an embodiment of the present invention.

In system 200, distributed computing applications such as face recognition 241 and trajectory generation 243 can be optimized to be placed in an optimal location 245 within the cloud and edge computing environment 201. The optimal location 245 can be the cloud server 203 or the edge server 205 depending on the optimal location 245.

The optimal location 245 can be determined by automatic placement of microservices with reinforcement learning 100 which is implemented in an analytic server 220. The analytic server 220 can communicate with a network 230 that further communicates with computing nodes 240. The computing nodes 240 can communicate with the end-users of the distributed computing applications such as decision-making entity 253 or autonomous vehicle 251.

In the face recognition 241 application, features of the face of a decision-making entity 253 can be processed and detected to perform additional downstream tasks such as authentication, entity monitoring, disease identification, etc.

In the trajectory generation 243, an autonomous vehicle 251 can have sensors that obtain data regarding a traffic scene which can be sent to the analytic server 220 through the network 230 to generate a trajectory to maneuver the autonomous vehicle 251 through the constructed traffic scene. Propulsion system of the autonomous vehicle 251 can move the autonomous vehicle 251 based on the trajectory generated by the analytic server 220. The autonomous vehicle 251 can include advanced driving assistance systems (ADAS) to also control the autonomous vehicle based on the trajectory.

By placing the distributed computing applications to the optimal location 245, the distributed computing applications would have enough resources to run and to provide continuous, high-quality service and without interruptions. Additionally, by placing the distributed computing applications to the optimal location 245, the latency of the distributed computing applications is maintained or lessened while reducing cost.

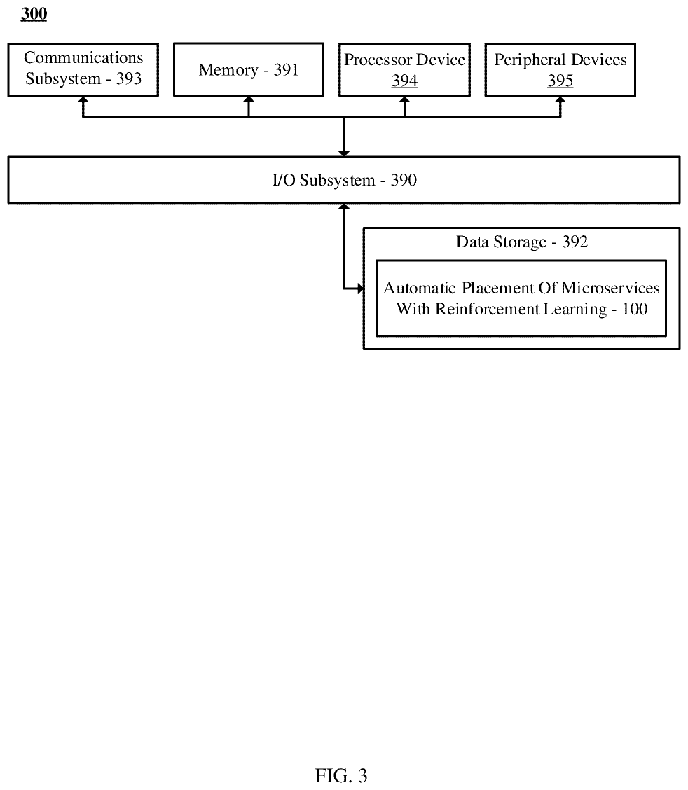

Referring now to FIG. 3, a block diagram showing a computing device implementing automatic placement of microservices with reinforcement learning, in accordance with an embodiment of the present invention.

The computing device 300 illustratively includes the processor device 394, an input/output (I/O) subsystem 390, a memory 391, a data storage device 392, and a communication subsystem 393, and/or other components and devices commonly found in a server or similar computing device. The computing device 300 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 391, or portions thereof, may be incorporated in the processor device 394 in some embodiments.

The processor device 394 may be embodied as any type of processor capable of performing the functions described herein. The processor device 394 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 391 may be embodied as any type of volatile or non-volatile memory or data storage capable of performing the functions described herein. In operation, the memory 391 may store various data and software employed during operation of the computing device 300, such as operating systems, applications, programs, libraries, and drivers. The memory 391 is communicatively coupled to the processor device 394 via the I/O subsystem 390, which may be embodied as circuitry and/or components to facilitate input/output operations with the processor device 394, the memory 391, and other components of the computing device 300. For example, the I/O subsystem 390 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 390 may form a portion of a system-on-a-chip (SOC) and be incorporated, along with the processor device 394, the memory 391, and other components of the computing device 300, on a single integrated circuit chip.

The data storage device 392 may be embodied as any type of device or devices configured for short-term or long-term storage of data such as, for example, memory devices and circuits, memory cards, hard disk drives, solid state drives, or other data storage devices. The data storage device 392 can store program code for automatic placement of microservices with reinforcement learning 100. Any or all of these program code blocks may be included in a given computing system.

The communication subsystem 393 of the computing device 300 may be embodied as any network interface controller or other communication circuit, device, or collection thereof, capable of enabling communications between the computing device 300 and other remote devices over a network. The communication subsystem 393 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 300 may also include one or more peripheral devices 395. The peripheral devices 395 may include any number of additional input/output devices, interface devices, and/or other peripheral devices. For example, in some embodiments, the peripheral devices 395 may include a display, touch screen, graphics circuitry, keyboard, mouse, speaker system, microphone, network interface, and/or other input/output devices, interface devices, GPS, camera, and/or other peripheral devices.

Of course, the computing device 300 may also include other elements (not shown), as readily contemplated by one of skill in the art, as well as omit certain elements. For example, various other sensors, input devices, and/or output devices can be included in computing device 300, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 300 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

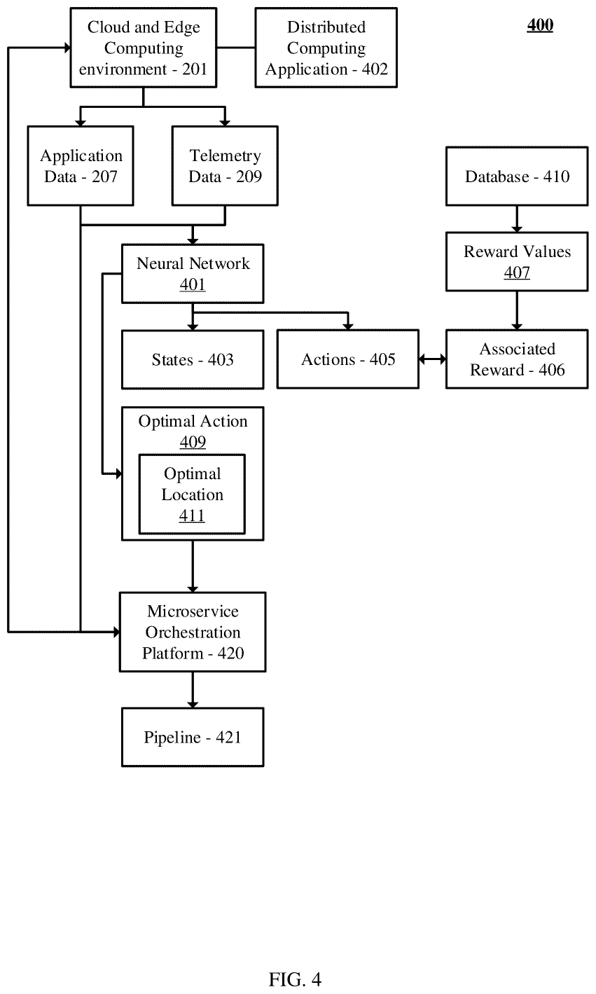

Referring now to FIG. 4, a block diagram showing hardware and software components employed to perform the operations in automatic placement of microservices with reinforcement learning, in accordance with an embodiment of the present invention.

In system 400, application data 207 and telemetry data 209 can be obtained from the cloud and edge computing environment 201 running the distributed computing application 402. The application data 207 and telemetry data 208 can be fed into a neural network 401 that performs reinforcement learning to generate states 403, actions 405, and computes associated rewards 406 based on reward values 407 (e.g., scenarios) that are stored in a database 410. After the exploration and exploitation of the agent of the neural network 401, an optimal action 409 can be generated. The optimal action 409 can include the optimal location 411 where the microservices can be placed. The optimal action 409 can be fed into a microservice orchestration platform 420 which generates a pipeline 421 that represents the data flow of the cloud and edge computing environment which includes the optimal location 411. The microservice orchestration platform 420 can place distributed computing application 402 to the optimal location 411 within the cloud and edge computing environment 201.

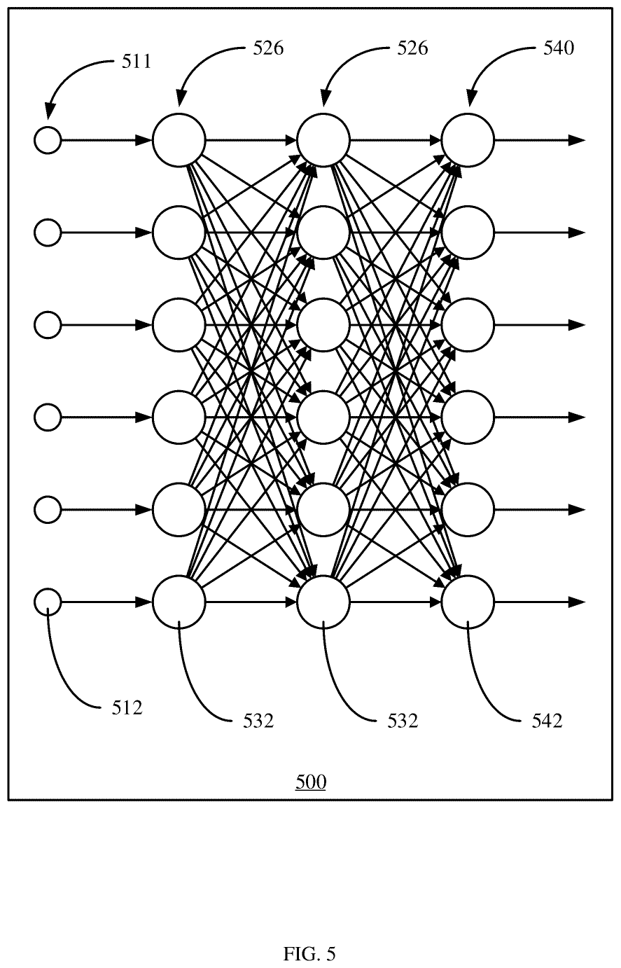

Referring now to FIG. 5, a block diagram showing a structure of deep neural networks for automatic placement of microservices with reinforcement learning, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the neural network 401 can learn relationships between actions 405 and associate rewards 406. The output layer 540 of the neural network 401 can then provide the overall response of the network as a likelihood that the state-action values (e.g., q-learnings) are the optimal action 409. The neural network 401 can also learn the scenarios where rule-based and automatic placement of the microservices based on past data and the collected microservices data.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
learning actions for an agent based on states and an associated reward for the actions based on a cost and latency of microservices of a distributed computing application with a reinforcement learning model;
generating an optimal action based on a top ranked action with an associated reward that maximizes a reward value based on the cost and the latency of microservices with the reinforcement learning model; and
placing the microservices to an optimal location within a cloud and edge computing environment that satisfies the latency and the cost of the microservices based on the optimal action.

2. The computer-implemented method of claim 1, wherein the distributed computing application further comprises trajectory generation for controlling an autonomous vehicle based on input data collected by sensors.

3. The computer-implemented method of claim 1, wherein learning the actions further comprises transforming collected microservice data and telemetry data into states as a workload experienced at a given time.

4. The computer-implemented method of claim 2, wherein learning the actions further comprises training the agent to determine actions based on the states having associated rewards including a high reward value when latency is satisfied at a low cost, a low reward value when latency is satisfied at a high cost, a low reward value when latency is not satisfied at a low cost, and a low reward value when latency is not satisfied at a high cost.

5. The computer-implemented method of claim 1, wherein generating the optimal action further comprises determining an accuracy of the actions based on newly collected data by exploring the actions.

6. The computer-implemented method of claim 1, wherein generating the optimal action further comprises simulating actions based on the states and the associated rewards for the actions.

7. The computer-implemented method of claim 1, wherein placing the microservices further comprises generating a pipeline for the microservices that manages a data transfer between entities in the cloud and edge computing environment for the distributed computer application.

8. A system, comprising:
a memory device;
one or more processor devices operatively coupled with the memory device to perform operations including:
learning actions for an agent based on states and an associated reward for the actions based on a cost and latency of microservices of a distributed computing application with a reinforcement learning model;
generating an optimal action based on a top ranked action with an associated reward that maximizes a reward value based on the cost and the latency of microservices with the reinforcement learning model; and
placing the microservices to an optimal location within a cloud and edge computing environment that satisfies the latency and the cost of the microservices based on the optimal action.

9. The system of claim 8, wherein the distributed computer application further comprises trajectory generation for controlling an autonomous vehicle based on input data collected by sensors.

10. The system of claim 8, wherein learning the actions further comprises transforming collected microservice data and telemetry data into states as a workload experienced at a given time.

11. The system of claim 10, wherein learning the actions further comprises training the agent to determine actions based on the states having associated rewards including a high reward value when latency is satisfied at a low cost, a low reward value when latency is satisfied at a high cost, a low reward value when latency is not satisfied at a low cost, and a low reward value when latency is not satisfied at a high cost.

12. The system of claim 8, wherein generating the optimal action further comprises determining an accuracy of the actions based on newly collected data by exploring the actions.

13. The system of claim 8, wherein generating the optimal action further comprises simulating actions based on the states and the associated rewards for the actions.

14. The system of claim 8, wherein placing the microservices further comprises generating a pipeline for the microservices that manages a data transfer between entities in the cloud and edge computing environment for the distributed computer application.

15. A non-transitory computer program product comprising a computer readable storage medium including program code for automatic placement of microservices with reinforcement learning, wherein the program code when executed on a computer causes the computer to perform operations having:
learning actions for an agent based on states and an associated reward for the actions based on a cost and latency of microservices of a distributed computing application with a reinforcement learning model;
generating an optimal action based on a top-ranked action with an associated reward that maximizes a reward value based on the cost and the latency of microservices with the reinforcement learning model; and
placing the microservices to an optimal location within a cloud and edge computing environment that satisfies the latency and the cost of the microservices based on the optimal action.

16. The non-transitory computer program product of claim 15, wherein the distributed computer application further comprises trajectory generation for controlling an autonomous vehicle based on input data collected by sensors.

17. The non-transitory computer program product of claim 15, wherein learning the actions further comprises training the agent to determine actions based on the states transformed from collected microservice data and telemetry data at a given time.

18. The non-transitory computer program product of claim 15, wherein generating the optimal action further comprises determining an accuracy of the actions based on newly collected data by exploring the actions.

19. The non-transitory computer program product of claim 15, wherein generating the optimal action further comprises simulating actions based on the states and the associated rewards for the actions including a high reward value when latency is satisfied at a low cost, a low reward value when latency is satisfied at a high cost, a low reward value when latency is not satisfied at a low cost, and a low reward value when latency is not satisfied at a high cost.

20. The non-transitory computer program product of claim 15, wherein placing the microservices further comprises generating a pipeline for the microservices that manages a data transfer between entities in the cloud and edge computing environment for the distributed computer application.
